(19) United States
(12) Patent Application Publication
(10) Pub. No.: US 2024/0362168 A1
(43) Pub. Date: Oct. 31, 2024

(54) COMPRESSION TECHNIQUE FOR LOGICAL-TO-PHYSICAL TABLE ENTRIES

(71) Applicant: International Business Machines Corporation, Armonk, NY (US)

(72) Inventors: Radu Ioan Stoica, Zurich (CH); Timothy J. Fisher, Cypress, TX (US); Nikolaos Papandreou, Thalwil (CH); Roman Alexander Pletka, Uster (CH); Aaron Daniel Fry, Richmond, TX (US); Charalampos Pozidis, Thalwil (CH); Andrew D. Walls, San Jose, CA (US)

(21) Appl. No.: 18/307,838

(22) Filed: Apr. 27, 2023

(51) Int. Cl. G06F 12/1009

(52) U.S. Cl. CPC G06F 12/1009

(57) ABSTRACT

A computer-implemented method, a computer program product, and a computer system for handling logical-to-physical table (LPT) entries. A computer implements a class of metadata including a logical-to-physical table (LPT) and LPT entries corresponding to the class of metadata. A computer caches, from the logical-to-physical translation layer, selected metadata blocks in a non-durable cache, the selected metadata blocks being selected from the class of metadata. A computer reduces a size of the selected metadata blocks by encoding the LPT entries from the non-durable cache during write operations to a flash memory. A computer records a location in flash memory of the encoded LPT entries in the logical-to-physical translation layer.

### BACKGROUND

The present invention relates generally to the field of solid-state storage, and more particularly to a compression technique for logical-to-physical table (LPT) entries.

Flash memory is an electronic non-volatile computer memory storage medium that can be electrically erased and reprogrammed. The two main types of flash memory, NOR flash and NAND flash, are named for the NOR and NAND logic gates, respectively. Both use the same cell design, consisting of floating gate MOSFETs. In NAND flash, the relationship between the bit line and the word lines resembles a NAND gate. NAND flash memory is a type of non-volatile storage technology that does not require power to retain data. NAND flash memory is used in devices where large files are frequently uploaded and replaced, such as MP3 players, digital cameras, and USB flash drives.

Solid-state drives (SSDs) are the most common storage drives today. SSDs are noiseless and allow PCs to be thinner and more lightweight. An SSD controller, also referred to as a processor, includes the electronics that bridge the flash memory components to the SSD input/output (I/O) interfaces. The controller has a number of channels, or buses, to speak with the NAND flash. The SSD controller is an embedded processor that executes firmware-level software. The SSD controller has its own firmware, ROM, and SRAM, but can also have DRAM to help with metadata.

### SUMMARY

In one aspect of the present invention, a method, a computer program product, and a system includes: implementing a class of metadata including a logical-to-physical table (LPT) and LPT entries corresponding to the class of metadata; caching, from the logical-to-physical translation layer, selected metadata blocks in a non-durable cache, the selected metadata blocks being selected from the class of metadata; reducing a size of the selected metadata blocks by encoding the LPT entries from the non-durable cache during write operations to a flash memory; and recording a location in flash memory of the encoded LPT entries in the logical-to-physical translation layer.

In another aspect of the present invention, a method, a computer program product, and a system includes increasing a spatial locality of the written data by re-ordering the user I/O write requests according to related sequential data streams where there are multiple sequential data streams being written concurrently to the flash memory.

In yet another aspect present invention, a method, a computer program product, and a system includes encoding the LPT entries by: reorganizing the LPT entries of the selected blocks according to field type such that fields of a first type are grouped together sequentially; and applying encoding methods based on field types of the LPT entries, including the first type.

### BRIEF DESCRIPTION OF THE SEVERAL VIEWS OF THE DRAWINGS

FIG. 1 is a schematic view of a first embodiment of a system according to the present invention;

FIG. 2 is a first table showing information that is generated by and/or helpful in understanding embodiments of the present invention;

FIG. 3 is a system flow diagram of a second embodiment of a system according to the present invention;

FIG. 4A is a first chart showing information that is generated by and/or helpful in understanding embodiments of the present invention;

FIG. 4B is a second chart showing information that is generated by and/or helpful in understanding embodiments of the present invention;

FIG. 5A is a flowchart showing a method performed, at least in part, by the first embodiment system;

FIG. 5B is a flowchart showing another method performed, at least in part, by the first embodiment system;

FIG. 6 is a schematic view of a machine logic (for example, software) portion of the first embodiment system;

FIG. 7 is a screenshot view showing information that is generated by and/or helpful in understanding embodiments of the present invention;

FIG. 8 is a second table showing information that is generated by and/or helpful in understanding embodiments of the present invention; and

FIG. 9 is a screenshot view showing information that is generated by and/or helpful in understanding embodiments of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as solid-state drive (SSD) controller 600. In addition to block 600, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 600, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

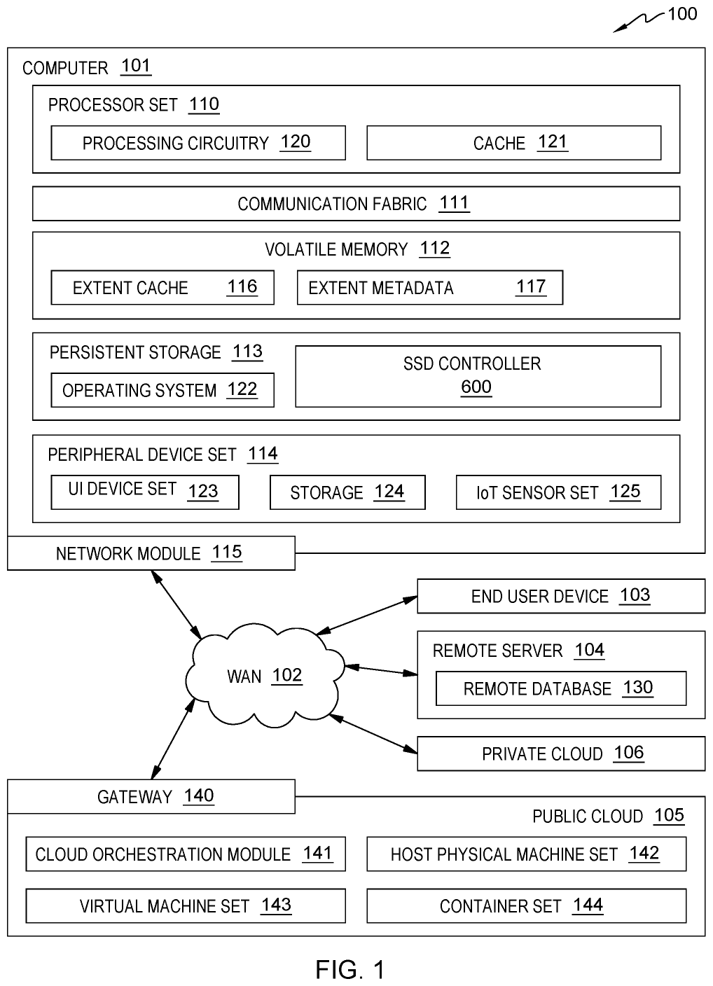

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 600 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (DRAM) or static type random access memory (SRAM). Typically, the volatile memory is characterized by random access, but this is not required unless affirmatively indicated. Extent cache 116 stores frequently accessed extents in a fast access memory, such as DRAM. Extent metadata 117 includes information about an extent, which may include the location in flash, size of the extent, straddling status, extent status (dirty or clean), access heat, and/or write heat. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 600 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Some embodiments of the present invention recognize the following facts, potential problems and/or potential areas for improvement with respect to the current state of the art of physical-to-logical metadata management in a solid state drive (SSD) controller: (i) NAND flash does not allow in-place updates as it requires erasing a full block before programming individual pages; (ii) the general workaround is to implement an indirection layer that allows transparently writing data to a different physical location; (iii) the indirection layer primarily consists of a Logical-to-Physical Table (LPT) that maps each logical block address (LBA) to a corresponding physical location including die, plane, lane, block, page, codeword, straddle status, and offset; (iv) the LPT metadata is usually too large to fully store in DRAM for high-capacity SSDs because the metadata size is proportional to storage capacity, so as NAND density continues to grow, the LPT metadata size grows at the same rate and while compression increases user capacity it requires a larger LPT table (for example, a 40 TB card requires approximately a 15 GB DRAM for storing LPT metadata, which lead to increased cost, power, and/or board space limitations; and/or (v) some computer data storage modules use LPT paging.

According to some embodiments of the present invention, multiple LPT entries are grouped into larger units (extents) that can be paged between the SSD controller DRAM and NAND flash media. To minimize paging impact, the LPT extent metadata is separated from the user data and stored in dedicated single-level cell (SLC) stripes, which allow LPT reads/writes with order of magnitude lower latency than multi-bit blocks. Separating metadata from user data ensures extent garbage collection (GC) is more efficient as it does not need to relocate user data. According to an embodiment of the present invention, 1024 LPT entries are grouped in an extent such that each extent is stored in a full codeword.

Some embodiments of the present invention recognize the following facts, potential problems and/or potential areas for improvement with respect to the current state of the art of physical-to-logical metadata management in an SSD controller. Modern improvements to extent paging may increase over-provisioning for extent GC as the LPT paging is in the critical path of user I/O. Such an approach has several limitations. First, write amplification of the LPT (WA_{LPT}) cannot be reduced to less than one. Second, increasing SLC overprovisioning leads to a significant capacity reduction as SLC blocks have a reduced capacity over blocks in multi-bit mode and leads to reduced user over-provisioning or higher cost per GB. Modern improvements to extent paging may implement write heat segregation, which is an orthogonal method to reduce WA_{LPT}. However, such an approach also comes with limitations. First, WA_{LPT} cannot be reduced below one, and the flash capacity allocated for LPT metadata cannot be reduced. Second, the number of write streams an SSD controller can support is limited. Increasing the number of write streams for the LPT metadata reduces the number of write streams available for writing user data and increases user Write Amplification (WAᵤₛₑᵣ). Modern improvements to extent paging may increase mapping granularity (e.g., increasing the logical-to-physical mapping from 8-16 kB to 32-128 KB). This approach induces a worse write performance for small writes, increases controller complexity, and introduces an additional source of performance variability.

Some embodiments of the present invention are directed to addressing issues of space overhead due to utilization of blocks when operating in single-level cell (SLC) mode, and/or issues where extents are blocking for user writes including: (a) cannot evict, flush, and/or garbage collect extents; (b) cannot update LPT metadata; and/or (c) cannot complete user writes, issues when write amplification for LPTs (WA_{LPT}) cause a significant reduction in the duration of SSD lifetimes, and the large performance impact for random write-heavy workloads. These issues often arise during updating of the LPT entry associated with the target LBA during a user write operation, which can trigger the following sequence of operations: (i) evict another extent (asynchronously), page-in the target extent & modify the extent; (ii) journal changes (write two journal entries) to ensure durability of LPT changes in case of a crash; (iii) when a journal ledger is full, all dirty extents that are part of a journal ledger must be written to flash but the flush process writes a new version of the extents and the previous version of the extents are logically invalidated; and (iv) the SLC stripes containing invalid extents must be garbage collected (GC), which results in an increase of WA_{LPT}.

Additionally, the stated issues may arise because extent writes may occur very frequently or even there can be multiple extent writes for each user's LBA write. For example, one user LBA write entry may initiate one extent write for updating the LBA entry, multiple extent writes required for relocating data for user GC, and multiple extent writes for performing extent GC. The total write I/O amplification may be written as the following equation:

$$I / O Amplification = Number of user writes \times {WA}_{user} \times ( 1 + {WA}_{LPT} )$$

Because many real-world workloads are composed of large writes or semi-sequential writes and in the case of workloads with spatial locality, LPT entries contain redundant information in that the fields of LPT entries that are part of the same extent are similar, one may exploit the similarity of the fields to compress/encode LPT entries within an extent to reduce the LPT size. Reducing the extent size will result in lower utilization of SLC blocks, higher effective over-provisioning for extent GC, and lower extent IO bandwidth. By applying LPT compression, the write amplification WA_{LPT} can be reduced to less than one.

Some embodiments of the present invention recognize that a general-purpose hardware (HW) compression scheme has many drawbacks including implementation complexity, circuit overhead, power consumption, added latency for blocking compressors, and bandwidth limitations. These drawbacks make using a general-purpose compressor undesirable for compressing extents. Accordingly, an extent compression technique is disclosed herein that is specifically designed for compressing/encoding LPT entries. This technique avoids the drawbacks of a general-purpose compressor.

Some embodiments of the present invention utilize a specialized compressor that exploits detailed information about the field structure of the logical-to-physical table (LPT) and similarity of LPT entries to reduce implementation complexity compared to general purpose compression and to ensure a maximum compression ratio.

Some embodiments of the present invention use an offline process to improve LPT encoding methods for establishing a compression scheme.

Some embodiments of the present invention are directed to a method including: (i) observing entry similarity in a logical-to-physical table (LPT) by running a variety of workloads; (ii) performing clustering of similar entries based on the experimental data; (iii) identifying LPT patterns requiring different encoding schemes; and (iv) implementing LPT encoding methods in the hardware as part of an established compression scheme.

For a delta-based compression scheme, the number of encoding methods and the number of delta bits are selected for each field and for each encoding method. For example, for one compression scheme, it may be observed that a combination of two LPT encoding methods handle a variety of workloads. To differentiate between the LPT encoding methods, each LPT entry is prefixed with a symbol that identifies the particular encoding scheme.

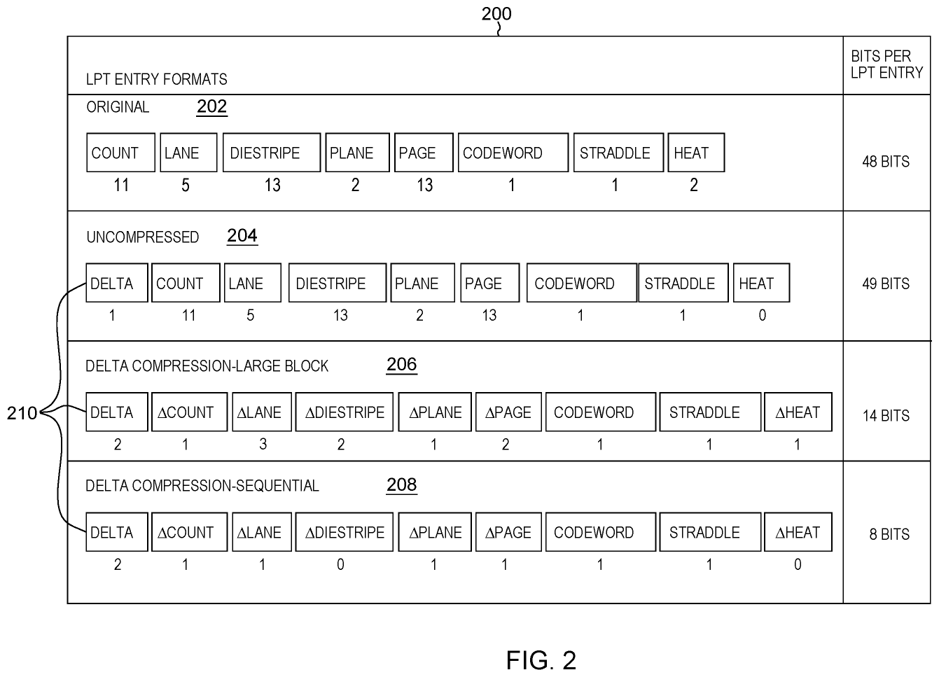

Computer data storage modules may be based on solid state technology and may use peripheral component interconnect (PCI) express attachment and a nonvolatile memory express (NVMe) command set. Oftentimes, computer data storage models use logical-to-physical tables (LPT) including LPT entries for mapping logical block addresses (LBA) to corresponding physical locations including die, plane, lane, block, page, codeword, straddle status, and offset. Example LPT entry formats are illustrated in FIG. 2 including original, or conventional, format 202. Some embodiments of the present invention are directed to modified LPT entry formats illustrated in screenshot 200 as uncompressed format 204, delta compression-large block format 206, and delta compression-sequential format 208.

According to some embodiments of the present invention, coding scheme symbols 210 are used as prefixes of each modified LPT entry. In this example, the coding scheme symbols are generated using a Huffman alphabet such that the most common encoding schemes are assigned the shortest identification symbols. It should be noted that as the number of encoding methods increases, the complexity increases, leading to the use of longer identification symbols, which operates to reduce the compression ratio.

Some embodiments of the present invention are directed to compressing an LPT extent by selecting the most space efficient encoding method for each LPT entry when writing to flash. When reading the LPT extent, the process is reversed. In DRAM, the LPT entries are always stored unencoded to allow fast access.

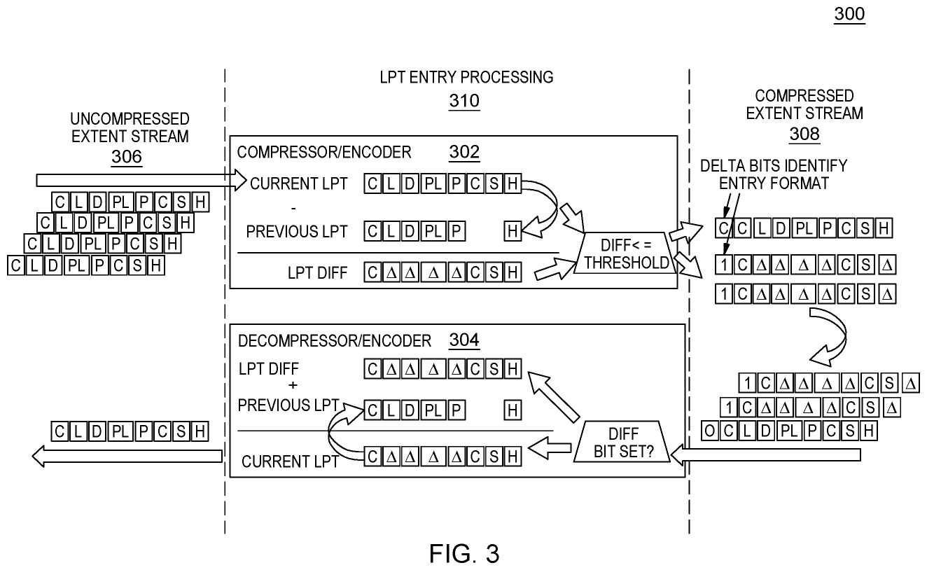

Some embodiments of the present invention are directed to an encoding process having an architecture as illustrated in FIG. 3, flash LPT compression architecture 300 including uncompressed extent stream 306; LPT entry processing component 310; compressor/encoder module 302; compressed extent stream 308; and decompressor/decoder module 304. The encoding process performed in the architecture may include the following process operations: (i) the fields of two sequential LPT entries, a current LPT entry, and a previous LPT entry, are subtracted to identify a difference; between each of the LPT entry fields; (ii) if the differences in the fields are less than a predefined per-field threshold, the current LPT entry is stored as a delta-encoded entry and where multiple encoding schemes are used, the encoding scheme that produces the most compact representation is utilized; and (iii) if the differences in the fields are higher than a predefined per-field threshold, the current LPT entry format is preserved and the previous LPT entry is stored.

The number of delta encodings and bits allocated for each field are selected based on profiling LPT entries for a variety of target workloads including, for example sequential workloads, random writes with large I/O sizes, and multiple sequential streams. As discussed herein, in this example, the modified LPT entry formats include identification fields that follow Huffman symbol notation.

Some embodiments of the present invention are directed to LPT compression schemes that produce extents of variable size on flash memory. According to some embodiments of the present invention, the proposed LPT compression techniques rely on extent straddling, which provides the ability to write a partial extent to a codeword and write the remainder to the next codeword in the stripe that can be located in another block on a different lane. Some embodiments of the present invention without extent straddling cannot write full flash, which significantly affects the compression ratio, wastes valuable SLC extent over-provisioned capacity, and increases GC extent overheads.

Some embodiments of the present invention implement extent straddling by modifying the extent tracking table metadata in a way that identifies if an extent straddles to the next codeword in a stripe. If an extent straddles two extents, both extents should be read in parallel to reduce latency.

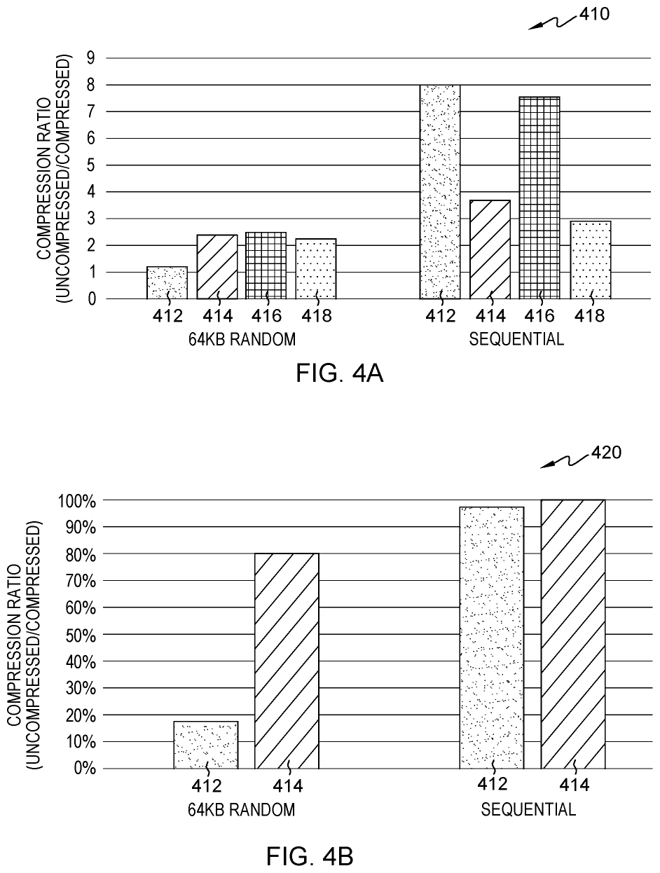

FIGS. 4A and 4B are graphs illustrating results of an LPT compressibility analysis for a selected compression scheme. The methodology used for performing the analysis is as follows: (i) run offline a set of representative workloads; (ii) store the LPT tables for each workload; (iii) implement and run multiple compression methods; (iv) compute the compression ratio for each method; and (v) select the fewest numbers of methods that maximizes the overall compression ratio.

Referring now to FIG. 4A, in bar graph 410, the selected compression methods include: (i) delta sequential method 412; (ii) delta large block method 414; (iii) delta hybrid method 416; and (iv) Gzip-9 method 418. The delta sequential method is a compression method optimized for sequential writes. The delta large block method is a compression method optimized for writes with spatial locality. The delta hybrid method is a compression method where the methods delta sequential and delta large block are chosen dynamically while processing workloads. The Gzip-9 (gzip with compression level 9) method is a state-of-the-art general purpose compression method. (Note: the term “GZIP” may be subject to trademark rights in various jurisdictions throughout the world and are used here only in reference to the products or services properly denominated by the marks to the extent that such trademark rights may exist.)

Delta compression methods 412, 414, and 416 are performed according to various embodiments of the present invention. These compression methods are compared to performance under the same methodology when running Gzip-9 method 418. The resulting compression ratios of the delta series of compression methods are generally more favorable than those of the Gzip-9 method with each of the delta method exceeding the compression ratio for sequential writes and only one delta method, 412, falling short of Gzip-9 in 64 kb random writes.

Referring now to FIG. 4B, in bar graph 420, the percentage of qualifying LPT entries for the delta compression methods, sequential and large-block, are illustrated. For a 64 kb random writes workload, the percentage of LPT entries qualifying for delta large block method 418 and the percentage of LPT entries qualifying for the delta sequential method 412 is illustrated. As a result, the large block compression method produces a higher compression ration than the sequential compression method. For a sequential write workload, the number of qualifying LPT entries is almost equal for both compression methods. As a result, the sequential compression method produces a higher compression ratio than the large block compression method. It should be noted that multiple LPT entry formats appear to be more desirable according to the analysis results shown in bar graph 420.

According to some embodiments of the present invention, certain workloads and assumptions are as follows: (i) 80% physical space utilization; (ii) random 64 kB writes; (iii) assuming a current extent write amplification (WA_{LPT}) having a value of two; (iv) assuming 75% of LPT entries can be compressed; (v) LPT entry average size: (0.25×49)+ (0.75×11)=21 bits; and (vi) the LPT size reduction is 48/21, or 2.29×. Under the above workloads and assumptions, the following advantages over existing art may include: (i) the required extent write bandwidth (due to either journal flushes or eviction) decreases by approximately 2.25× from baseline reference; (ii) extent garbage collection would be expected to decreased from 2 to approximately 1.1 due to higher extent over-provisioning; (iii) where WA_{LPT}=2, the effective over-provisioning is 28%; (iv) assuming constant physical capacity, the extent size reduction increases effective over-provisioning to 68%; and (v) total extent I/O write traffic decreases as follows

$$2.25 \times ( \frac{2}{1.1} ) = 4 X .$$

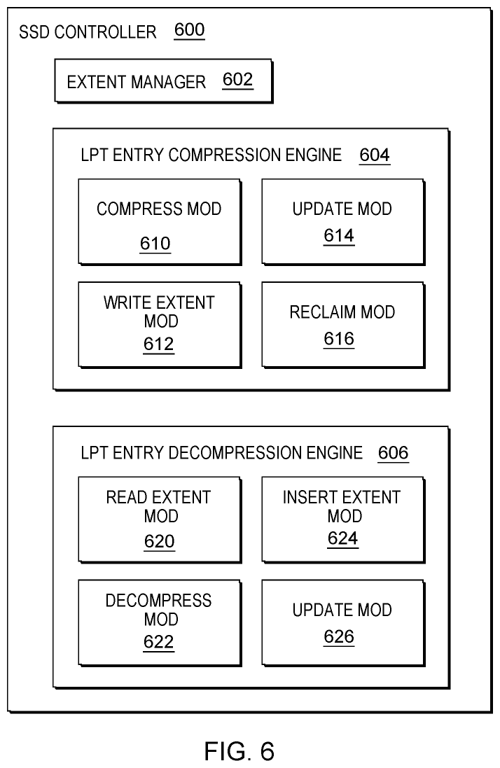

FIG. 6 show software details of solid-state drive (SSD) controller 600, which includes extent manager 602; logical-to-physical table (LPT) entry compression engine 604; and LPT entry decompression engine 606. Extent manager 602 operates to reduce the space and I/O overhead of the logical-to-physical mapping metadata in a solid-state storage controller. The extent manager 602 implements LPT-related logic, which may include: page-in and/or page-out, extent garbage collection, read and write heat tracking, and/or LPT metadata updates. The compression engine 604 compresses LPT entries when an extent is evicted. The extent metadata is updated to contain the start flash address, size, and, potentially, straddle information. The decompression engine 606 decompresses LPT entries when an extent is read, paged-in. The decompressed extent is added to the cache. The extent metadata is updated to indicate the location of the extent in the cache.

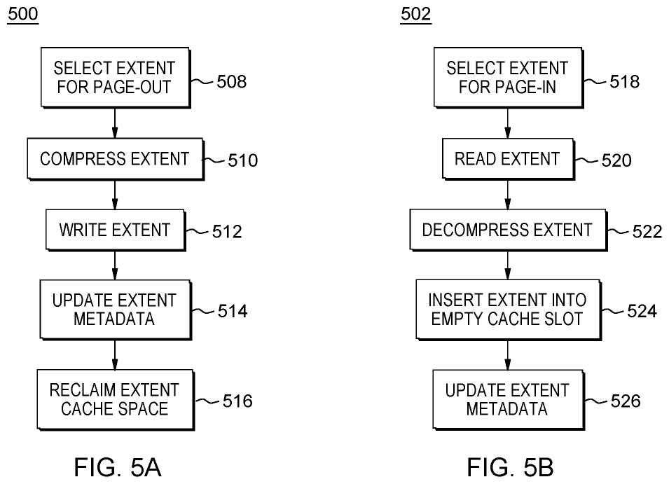

FIG. 5A shows flowchart 500 depicting a first method according to the present invention. FIG. 6 shows LPT entry compression engine 604 for performing at least some of the method steps of flowchart 500. This method and associated software will now be discussed, over the course of the following paragraphs, with extensive reference to FIG. 5A (for the method step blocks) and FIG. 6 (for the software blocks).

Processing begins at step 508, where extent manager 508 selects an extent for eviction, or page-out. Some embodiments of the present invention are directed to a method for a compression technique that is specifically designed for compressing/encoding Logical-To-Physical (LPT) entries. In this example, the implementation is performed by a solid-state NAND flash controller. The logical-to-physical translation layer may be implemented for a particular class of metadata, such as metadata that is classified as being too large to store in RAM.

Processing proceeds to step 510, where compress mod 610 compresses the selected extent.

Processing proceeds to step 512, where write extent mod 612 writes the compressed extent to flash media.

Processing proceeds to step 514, where update mod 614 updates the extent metadata by encoding the extent metadata when writing the extent to flash memory.

Processing ends at step 516, where reclaim mod 616 reclaims extent cache space.

FIG. 5B shows flowchart 502 depicting a second method according to the present invention. FIG. 6 shows LPT entry decompression engine 606 for performing at least some of the method steps of flowchart 502. This method and associated software will now be discussed, over the course of the following paragraphs, with extensive reference to FIG. 5B (for the method step blocks) and FIG. 6 (for the software blocks).

Processing begins at step 518, where extent manager 508 selects an extent for page-in.

Processing proceeds to step 520, where read extent module (“mod”) 620 reads the selected extent from flash media storage.

Processing proceeds to step 522, where decompress mod 622 decompresses the selected extent.

Processing proceeds to step 524, where insert extent mod 624 inserts the decompressed extent into an empty cache slot.

Processing ends at step 526, where update mod 626 updates the extent metadata of the inserted extent.

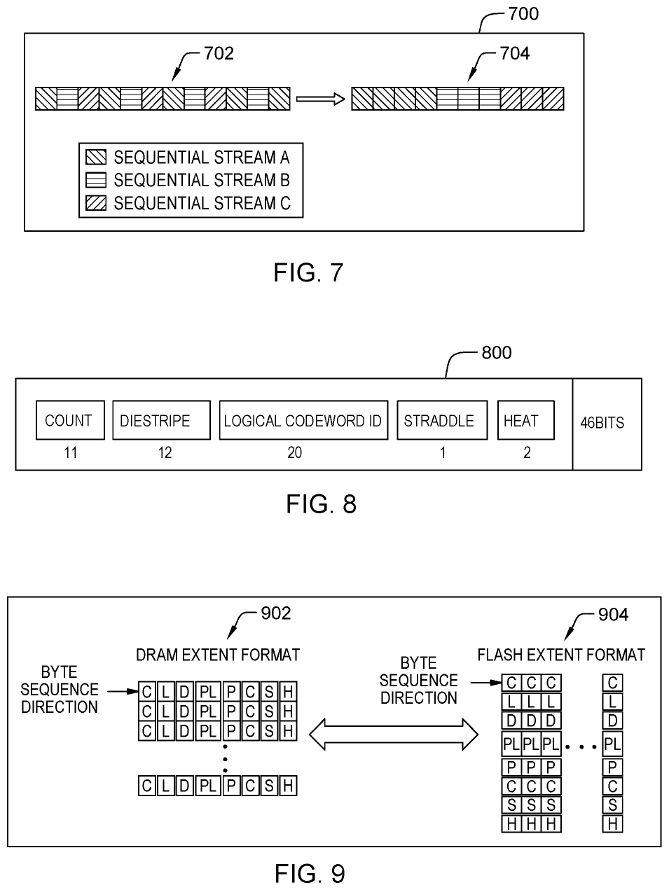

Further embodiments of the present invention are discussed in the paragraphs that follow with reference to FIGS. 7-9.

Referring now to FIG. 7, screenshot 700 depicts a write I/O re-order process according to some embodiments of the present invention. As shown in screenshot 700, a flash LPT compression process is shown where user write I/Os are re-ordered to reduce write stream mixing and increase spatial locality and increases the similarity between neighboring LPT entries. Reordering window 702 including user write I/Os is organized into ordered write stream 704 by selecting logical block address (LBA) that are sequential to an immediately previous write I/O with the oldest write I/O being selected when no sequential LBA is identified. An advantage of the synergy of the flash LPT compression process is the reduced garbage collection (GC) overhead.

Some embodiments of the present invention are directed to compression optimizations by improving the compression rate by considering nth previous LPT entries rather than just the last, especially with mixing I/O streams

As illustrated in FIG. 8, some embodiments of the present invention are directed to compression optimizations by reordering the LPT entry fields 800 to ensure high entropy fields are collocated and ordered sequentially, where a slight LPT size reduction (4%) may result but also the delta compression process may be more effective when high entropy fields are ordered and collocated.

Some embodiments of the present invention are directed to compression optimizations by splitting LPT fields column-wise, such as run-length encoding for repetitive fields (for dies, stripe, or plane) and delta encoding for increasing fields (lane).

Some embodiments of the present invention are directed to a flash LPT compression process including a background idle defrag for write cold data. Write cold data refers to data that is rarely written and therefore considered to be “write cold.” In this process, write cold data is rewritten sequentially such that spatial locality is increased.

FIG. 9 is a screenshot illustrating process 900 for column-wise LPT encoding. The encoding of the extents is transparently changed when paging in/out from flash, such as when paging out to flash extent format 904 from DRAM extent format 902. An extent may have a “column” format such that fields of the same type are stored sequentially according to a byte sequence direction. By organizing storage according to column format, the entropy is reduced, allowing for more efficient compression algorithms and resulting in a higher compression ratio. Performing encoding according to this process, certain characteristics will be recognized including: (i) the compressor/decompressor must have multiple buffers that can store both the compressed and decompressed extent formats; (ii) extent entries are updated one field at a time which increases computational overhead; and (iii) the compressor/decompressor are blocking/stopping such that data cannot be streamed which increases latency.

Some embodiments of the present invention are directed to a solid-state NAND flash controller that has the following features and characteristics: (i) implements a logical-to-physical translation layer where the corresponding metadata is too large to store in RAM; (ii) the frequently accessed metadata blocks are cached in a non-durable cache (DRAM); and (iii) the controller, in response to user I/O requests or other internal operations, performs metadata I/O operations, including paging in/out metadata blocks from flash memory, journaling modifications to metadata blocks, and performing garbage collection (GC) of invalid metadata blocks. Further, the controller, as part of the process of writing a metadata block to flash, encodes each metadata block in order to reduce the overall metadata block size and, as part of the process of reading a metadata block from flash, decodes the metadata block before storing it in the cache.

Some embodiments of the present invention are directed to subtracting or XOR-ing the fields of two consecutive metadata entries during the encoding process. If the difference between is greater than a predefined set of thresholds, the metadata entry is stored uncompressed, otherwise the metadata entry is stored as a difference in a more space efficient format.

Some embodiments of the present invention are directed to selecting one encoding format from several potential encoding format candidates based on differences between the consecutive fields of two metadata entries.

Some embodiments of the present invention are directed to applying workload characteristics to generate a list of encoding format candidates.

Some embodiments of the present invention are directed to transparently re-organizing the fields of a metadata page are from a row-major format in memory to a column-major encoding format before writing the metadata page to persistent storage.

Some embodiments of the present invention are directed to reducing the metadata block further in size after the metadata page is re-organized in a column-major encoding, the reducing being due to encoding each sequence of attributes using a delta or run-length encoding scheme.

Some embodiments of the present invention are directed to prioritizing the user I/O write requests to increase the compressibility of the metadata blocks.

Some embodiments of the present invention are directed to implementing, by a storage controller, a background process that re-writes user data with the goal of maximizing the spatial locality and increasing the compressibility of the metadata blocks.

Some embodiments of the present invention are directed to providing an extent compression technique that is specifically designed for compressing/encoding Logical-To-Physical Table (LPT) entries to reduce the space and input/output (I/O) overhead of the logical to physical mapping metadata in a solid-state storage (SSD) flash controller with the following steps: (i) implementing a logical-to-physical translation layer where the corresponding metadata is too large to store in Random Access Memory (RAM); (ii) caching the frequently accessed metadata blocks in a non-durable cache (DRAM); (iii) performing metadata IO operations, including pages-in/-out metadata blocks from flash memory, journals modifications to metadata blocks, and performs garbage collection of invalid metadata blocks, by the controller, in response to user IO requests or other internal operations; (iv) re-organizing the fields of a metadata page transparently from a row-major format in memory to a column-major encoding before writing to persistent storage; (v) reducing the metadata block further in size by encoding each sequence of attributes using a delta or run-length encoding schemes, after the metadata page is re-organized in a column-major encoding; (vi) prioritizing the user IO write requests in order to increase the compressibility of the metadata blocks; (vii) implementing, by the storage controller, a background process that re-writes user data with the goal of maximizing the spatial locality and increase the compressibility of the metadata blocks; (viii) encoding each metadata block order to reduce the metadata block size, by the controller, as part of the process of writing a metadata block to flash, wherein the fields of two consecutive metadata entries are subtracted during the encoding process, and if the difference between all fields is greater than some predefined threshold, the metadata entry is stored uncompressed, otherwise the metadata entry is stored in a compressed/encoded format; (ix) selecting encoding format from several potential candidates based on the differences between the consecutive fields of two metadata entries; and (x) Decoding each metadata block before storing it in the cache, by the controller, as part of the process of reading a metadata blocks from flash.

Some embodiments of the present invention are directed to reducing the write amplification (WA_{LPT}) and space overhead due to paging of address translation metadata by compressing the L2P pages before writing them to flash memory. When reading, paging in, the L2P metadata pages, a full L2P page is decompressed and fully stored uncompressed in the DRAM cache to allow for fast access.

Some embodiments of the present invention are directed to compression methods that utilize delta encoding, which is more reliable in the presence of intermixed write streams and random writes.

Some embodiments of the present invention are directed to compressing L2P pages before writing them to persistent flash memory while keeping them uncompressed in DRAM for fast access and to utilizing delta encoding, which is more reliable in the presence of intermixed write streams and random writes.

Some embodiments of the present invention may include one, or more, of the following features, characteristics and/or advantages: (i) non-blocking compression; (ii) data can be streamed through the compressor without creating a performance bottleneck; (iii) low implementation complexity; (iv) low hardware circuit overhead; and/or (v) higher compression ratio than a general-purpose compressor.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above-similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for handling a logical-to-physical address translation table, the method comprising:
implementing a class of metadata including a logical-to-physical table (LPT) and LPT entries corresponding to the class of metadata;
caching, from the logical-to-physical translation layer, selected metadata blocks in a non-durable cache, the selected metadata blocks being selected from the class of metadata;
reducing a size of the selected metadata blocks by encoding the LPT entries from the non-durable cache during write operations to a flash memory; and
recording a location in flash memory of the encoded LPT entries in the logical-to-physical translation layer.

2. The computer-implemented method of claim 1, further comprising:
decoding the encoded LPT entries from the flash memory during read operations of the set of metadata blocks to the non-durable cache.

3. The computer-implemented method of claim 1, further comprising:
responsive to user input/output (I/O) write requests to write data, performing I/O operations on metadata blocks of the selected metadata blocks including page-in and page-out operations between the non-durable cache and a flash memory.

4. The computer-implemented method of claim 3, further comprising:
increasing a spatial locality of the written data by re-ordering the user I/O write requests according to related sequential data streams where there are multiple sequential data streams being written concurrently to the flash memory.

5. The computer-implemented method of claim 1, wherein encoding the LPT entries includes:
subtracting fields of two consecutive LPT entries; and
responsive to a resulting difference between the two consecutive LPT entries being less than a pre-defined threshold, storing the LPT entry as a difference in a selected encoding format.

6. The computer-implemented method of claim 4, further comprising:
selecting the selected encoding format from a plurality of candidate encoding formats based on the resulting difference.

7. The computer-implemented method of claim 1, wherein the encoding the LPT entries includes:
reorganizing the LPT entries of the selected blocks according to field type such that fields of a first type are grouped together sequentially; and
applying encoding methods based on field types of the LPT entries, including the first type.

8. A computer program product comprising a computer-readable storage medium having a set of instructions stored therein which, when executed by a processor, causes the processor to perform a method comprising:
implementing a class of metadata including a logical-to-physical table (LPT) and LPT entries corresponding to the class of metadata;
caching, from the logical-to-physical translation layer, selected metadata blocks in a non-durable cache, the selected metadata blocks being selected from the class of metadata;
reducing a size of the selected metadata blocks by encoding the LPT entries from the non-durable cache during write operations to a flash memory; and
recording a location in flash memory of the encoded LPT entries in the logical-to-physical translation layer.

9. The computer program product of claim 8, the set of instructions further causing the processor to perform the method comprising:
decoding the encoded LPT entries from the flash memory during read operations of the set of metadata blocks to the non-durable cache.

10. The computer program product of claim 8, the set of instructions further causing the processor to perform the method comprising:
responsive to user input/output (I/O) write requests to write data, performing I/O operations on metadata blocks of the selected metadata blocks including page-in and page-out operations between the non-durable cache and a flash memory.

11. The computer program product of claim 10, the set of instructions further causing the processor to perform the method comprising:
increasing a spatial locality of the written data by re-ordering the user I/O write requests according to related sequential data streams where there are multiple sequential data streams being written concurrently to the flash memory.

12. The computer program product of claim 8, wherein encoding the LPT entries includes:
subtracting fields of two consecutive LPT entries; and
responsive to a resulting difference between the two consecutive LPT entries being less than a pre-defined threshold, storing the LPT entry as a difference in a selected encoding format.

13. The computer program product of claim 8, the set of instructions further causing the processor to perform the method comprising:
selecting the selected encoding format from a plurality of candidate encoding formats based on the resulting difference.

14. A computer system for handling logical-to-physical table (LPT) entries, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
implementing a class of metadata including a logical-to-physical table (LPT) and LPT entries corresponding to the class of metadata;
caching, from the logical-to-physical translation layer, selected metadata blocks in a non-durable cache, the selected metadata blocks being selected from the class of metadata;
reducing a size of the selected metadata blocks by encoding the LPT entries from the non-durable cache during write operations to a flash memory; and
recording a location in flash memory of the encoded LPT entries in the logical-to-physical translation layer.

15. The computer system of claim 14, the set of instructions further causing the processor to perform the method comprising:
decoding the encoded LPT entries from the flash memory during read operations of the set of metadata blocks to the non-durable cache.

16. The computer system of claim 14, the set of instructions further causing the processor to perform the method comprising:
responsive to user input/output (I/O) write requests to write data, performing I/O operations on metadata blocks of the selected metadata blocks including page-in and page-out operations between the non-durable cache and a flash memory.

17. The computer system of claim 16, the set of instructions further causing the processor to perform the method comprising:
increasing a spatial locality of the written data by re-ordering the user I/O write requests according to related sequential data streams where there are multiple sequential data streams being written concurrently to the flash memory.

18. The computer system of claim 14, wherein encoding the LPT entries includes:
subtracting fields of two consecutive LPT entries; and
responsive to a resulting difference between the two consecutive LPT entries being less than a pre-defined threshold, storing the LPT entry as a difference in a selected encoding format.

19. The computer system of claim 14, the set of instructions further causing the processor to perform the method comprising:
selecting the selected encoding format from a plurality of candidate encoding formats based on the resulting difference.

20. The computer system of claim 14, wherein the encoding the LPT entries includes:
reorganizing the LPT entries of the selected blocks according to field type such that fields of a first type are grouped together sequentially; and
applying encoding methods based on field types of the LPT entries, including the first type.
